(19) United States
(12) Patent Application Publication
(10) Pub. No.: US 2002/0134575 A1
(43) Pub. Date: Sep. 26, 2002

(54) Insulating nut holder for electrical component package

(76) Inventor: Tony Tong, Sunnyvale, CA (US)

Correspondence Address: SKJERVEN MORRILL LLP, 25 METRO DRIVE, SUITE 700, SAN JOSE, CA, 95110, US

(21) Appl. No.: 09/816,947

(22) Filed: Mar. 22, 2001

(51) Int. Cl. H01B 17/00

(52) U.S. Cl. 174/138 G

(57) ABSTRACT

An insulating nut holder for mounting an electrical component package to a heat sink includes a plastic body, and a metal nut encapsulated in the plastic body. An adhesive coating is applied to a surface of the insulating nut holder for adhering the nut holder to the electrical component package. In use, the insulating nut holder is adhered to the electrical component package aligning the bores. The assembly is mounted to the heat sink, aligning the bores in the assembly with a hole in the heat sink plate. The fastener (mounting bolt) can be threaded in the metal nut from the heat sink plate side without holding the nut to prevent it from rotating when the fastener is tightened.

### FIELD OF INVENTION

This disclosure relates to electrical or electronic components and more specifically to a nut holder for mounting electrical components.

### BACKGROUND

FIGS. 1A and 1B illustrate in a side view and a front view respectively, a conventional method of mounting (e.g., on a cooling plate) an electrical or electronic component package 10 (for holding, for instance, a standard discrete transistor or integrated circuit in a T0247 or T0220 package) using a plastic nut 12 and a plastic bolt (or screw) 14. In FIGS. 1A and 1B cooling plate 16 may be the wall of an enclosure for electronic circuitry that houses a circuit board 11 (only a part of which is shown). Only a portion of enclosure wall is shown in FIGS. 1A and 1B. Package 10 is mounted on the circuit board 11 by soldering terminals 13A, 13B and 13C to circuit board 11. Package 10 is mounted on cooling plate (i.e., heat sink) 16, aligning the bores in cooling plate 16 and package 10 for accommodating bolt 14. Nut 12 is placed on one side of plate 16 and bolt 14 is threaded through the opposite side thereby capturing package 10 and cooling plate 16 between nut 12 and the head of bolt 14. The tightening of bolt 14 provides pressure between package 10 and cooling plate 16 thereby establishing proper heat transfer between cooling plate 16 and package 10

When bolt 14 and nut 12 are metal instead of being plastic, it is usual practice to electrically insulate bolt 14 and nut 12 from cooling plate 16 which is typically electrically conductive. It may also be necessary to provide electrical insulation between package 10 and cooling plate 16. When such electrical insulation is used, the electrical insulation between package 10 and cooling plate 16 is provided by a material that has good thermal conductivity.

Another conventional apparatus for mounting such a package is a cam holder. Here, again, a plastic bolt and nut are used in conjunction with a wedge to press together the component package and cooling plate.

Such methods, of course, require access from two sides to install (or remove); from one side bolt 14 is inserted and tightened, and while bolt 14 is being tightened, nut 12 is held from the other side thereby preventing rotation of nut 12. Such two-sided access is not available in many electrical assemblies. Thus, it is desirable that the mounting of package 10 be done efficiently from one side.

Plastic bolt 14 and nut 12 are adequate to provide, initially, the necessary pressure between package 10 and cooling plate 16. However, with the passage of time, the plastic creeps. This results in reduced pressure at the mating surface, which results in reduced heat transfer, which in turn results in overheating and ultimate failure of package 10. Thus it is desirable to have the electrical insulating properties of plastic without the loss of pressure at the mating surfaces over time.

### SUMMARY

An insulating nut holder as disclosed here overcomes aforementioned shortcomings of the prior art component package mounting, and provides a cost-effective method of mounting a component package, while maximizing flexibility in circuit design and layout.

The insulating nut holder in certain embodiments includes a plastic (electrically insulating) body, and a metal nut encapsulated in the plastic body. The bore in the metal nut is concentric with a bore defined through the plastic body. The plastic body also has a sleeve on one side, the sleeve defining an opening that is concentric with the bore in the body and the bore in the metal nut. A ridge extends from the plastic body, and a lip extends from the distal end of the ridge, the lip being in a plane perpendicular to the side of the plastic body that has the sleeve. An adhesive coating is applied to the surface of the side with the sleeve.

In use, the insulating nut holder is adhered to the component package, aligning the bores in the insulating nut holder and the electrical component package. The assembly is placed near the cooling plate, (which may be any type of heat sink or support external to the component package), aligning the bore in the insulating nut holder with a bore on cooling plate. Then, a fastener, for example a bolt, is threaded in the metal nut from the cooling plate side without holding the metal nut to prevent it from rotating when the bolt is tightened. The fastener is a bolt, a machine screw, or any other suitable fastener that can be threaded in the metal nut.

### BRIEF DESCRIPTION OF THE DRAWINGS

FIGS. 1A, 1B illustrate a conventional method of mounting an electrical component package.

FIG. 2 is a perspective view of the present insulating nut holder.

FIG. 3A is an elevation view of the insulating nut holder of FIG. 2.

FIG. 3B is a plan view of the insulating nut holder of FIG. 2.

FIG. 3C is a side view of the insulating nut holder of FIG. 2.

FIG. 4A is a front view of a TO220 package mounted on a cooling plate using the insulating nut holder of FIG. 2.

FIG. 4B is a side view of assembly of FIG. 4A.

FIG. 5A is a front view of a TO247 package mounted on a cooling plate using the insulating nut holder of FIG. 2.

FIG. 5B is a side view of the assembly of FIG. 5A.

### DETAILED DESCRIPTION

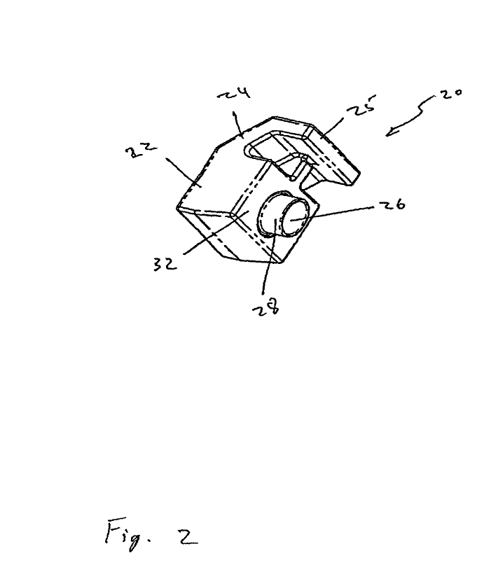

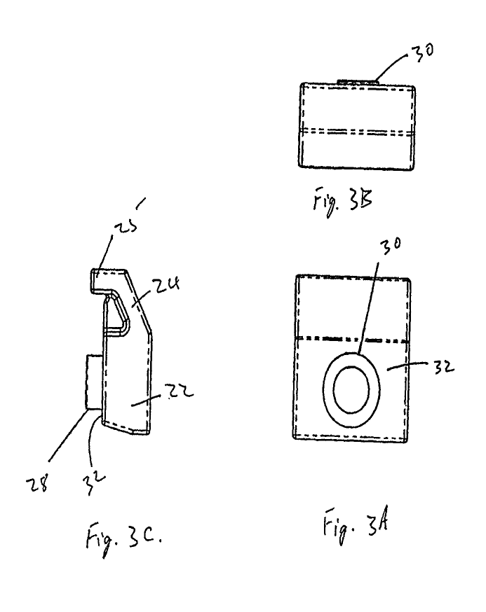

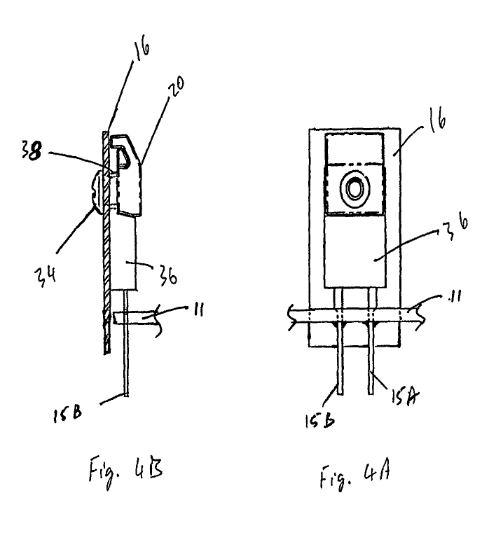

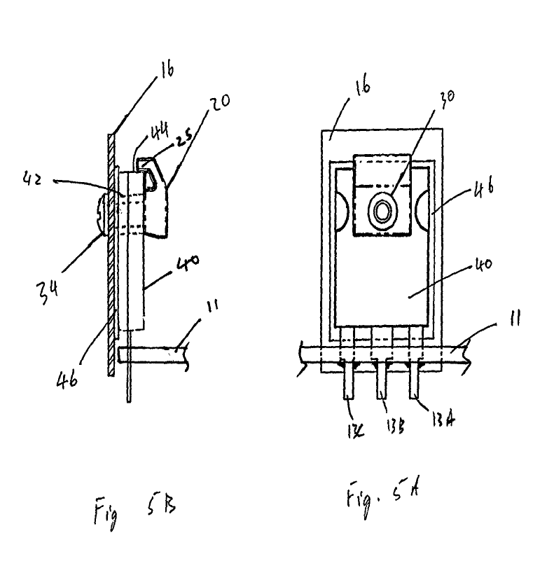

FIG. 2 is a perspective view of the present insulating nut holder 20 which includes a body 22, and extending from body 22 is a ridge 24 defining a lip 25 at its distal end. A central bore 26 is defined through body 22. Extending from one side of body 22 is a sleeve 28 which has substantially the same external diameter as bores 38 and 42 in one embodiment (see FIGS. 4B and 5B respectively). Bores 38 and 42 are defined in the body of, e.g., a TO220 package 36 or a TO247 package 40 (see FIGS. 4B and 5B respectively) to allow a fastener to be inserted through package 36 or package 40. Body 22 is made from an electrically insulating material; e.g. plastic. Captured within body 22, coaxial with sleeve 28, is a nut 30 (not visible in FIG. 2 but shown in the elevation view of FIG. 3A) made from a material in one embodiment that exhibits low creep. An example of such a material is steel. The threaded bore of nut 30 is substantially aligned with the opening in sleeve 28 and sleeve bore 26. An adhesive is applied on surface 32 of nut holder 20. The adhesive may be applied in the field just prior to use of nut holder 20 in an assembly as described below, or the adhesive may be applied during manufacture of nut holder 20. An example of a suitable adhesive is pressure sensitive adhesive tape F-9469PC made by 3M. The tape is die cut to a shape matching surface 32 and the die cut piece is adhered to surface 32. The exposed surface of the tape has a peel off layer that is peeled off to expose the pressure sensitive adhesive. A conventional (e.g., metallic) bolt (or other suitable fastener such as a machine screw) 34 (see FIG. 4B) passes through the coaxial bore in sleeve 28, bore 26, and engages the threads of nut 30. FIGS. 3B and 3C are respectively plan and side views of the FIG. 2 nut holder 20.

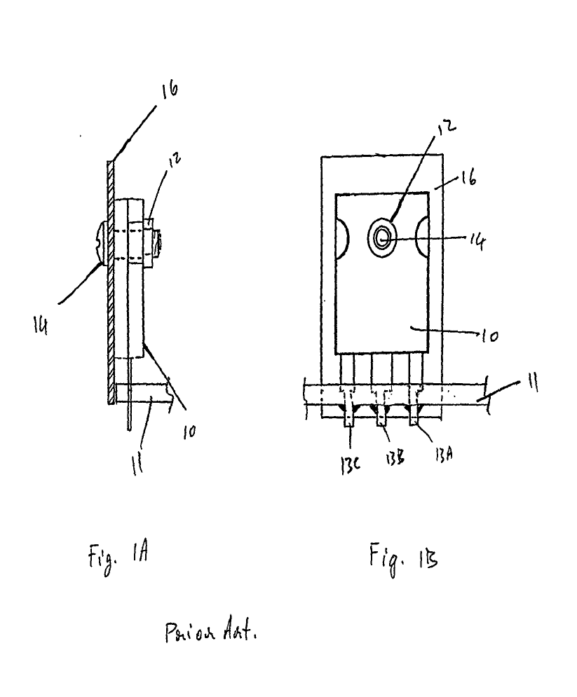

FIGS. 4A and 4B show an assembly including nut holder 20 securing an electrical component package, for example, a TO220 package 36, to cooling plate 16. Package 36 is of the type found on a circuit board 11 used in electronic equipment, for example, a personal computer. Package 36 requires additional heatsinking to dissipate the heat generated by the internal components such as diodes, transistors or integrated circuits; particularly components used in power conversion. Package 36 is mounted on circuit board 11 by soldering terminals 15A and 15B on circuit board 11. Cooling plate 16 is, as in FIG. 1A, e.g., the wall of the housing in which circuit board 11 is enclosed. Only a portion of cooling plate 16 is shown in FIGS. 1A, 1B, 4A, 4B, 5A, and 5B. Nut holder 20 is adhered to package 36 by adhesive coated surface 32 (see FIG. 2) being pressed on surface of package 36. The pressure sensitive adhesive on surface 32 attaches nut holder 20 to package 36, and maintains nut holder 20 in alignment during further assembly. Package 36 defines a bore 38 (see FIG. 4B) through its body. Bore 38 is aligned with bore 26 in nut holder 20. When nut holder 20 is attached to package 36, sleeve 28 is inserted in bore 38 of package 36. Sleeve 28, which is made from electrically insulating material, prevents the fastener, e.g., a bolt 34 from touching any internal electrically conductive components of package 36. The assembly of nut holder 20 and package 36 is in thermal contact with cooling plate 16. Package 36 makes thermal contact with cooling plate 16; this is achieved by pressing package 36 against cooling plate 16. The pressing is achieved by inserting bolt 34 through cooling plate 16 and into nut holder 20, and threading bolt 34 into nut 30. By tightening bolt 34 in nut 30, an appropriate amount of pressure between surface of package 36 and surface 22 is achieved.

FIGS. 5A and 5B show nut holder 20 being used to secure a somewhat different type of electrical component package, a TO247 package 40, to cooling plate 16. Package 40 defines a bore 42 (see FIG. 5B) through its body. Bore 42 is aligned with bore 26 in nut holder 20. Nut holder 20 is attached to package 40 via adhesive surface 32 (see FIG. 2) being in contact with the opposing surface of package 40. When nut holder 20 is thereby attached to package 40, sleeve 28 (shown in FIG. 2, not shown in FIGS. 4A, 4B, 5A, and 5B for clarity) is inserted in bore 42 of package 40. Sleeve 28, which is made of insulating material, prevents bolt 34 from touching any internal electrically conductive components of package 40. The assembly of nut holder 20 and package 40 is in thermal contact with cooling plate 16. Package 40 makes thermal contact with cooling plate 16. This is achieved by pressing package 40 against cooling plate 16; the pressing is achieved by inserting bolt 34 through cooling plate 16 and into nut holder 20, and threading bolt 34 into nut 30. By tightening bolt 34 into nut 30, an appropriate amount of pressure at the contacting surface of package 40 and cooling plate 16 is achieved. It is to be understood that any fastener that can be threaded in nut 30 can be used in place of bolt 34. When nut holder 20 is used with package 40, lip 25 contacts side 44 (see FIG. 5B) of package 40, thereby preventing rotation of nut holder 20 when bolt 34 is threaded into nut 30.

In one embodiment, sleeve 28 (see FIG. 2) is of such external dimension that it is force fit in bore 38 and bore 42. The force fit between sleeve 28 and bore 38 (see FIG. 4B) or bore 42 (see FIG. 5B) retains nut holder 20 in place, thereby eliminating the need for adhesive coating on surface 32.

In one embodiment a layer of insulating material 46 (see FIGS. SA and 5B) is located between package 40 and cooling plate 16 to prevent electrical contact between package 40 and cooling plate 16. Insulating material 46 (e.g., material made by Chomerics, a division of Parker Hannifin Corporation, and identified by Chomerics item number 1671) is a suitable electrical insulator, and is a good conductor of heat.

The embodiments described above are exemplary only; variations will be apparent in view of the above disclosure; the invention is limited only by the following claims.

I claim:

1. An insulating nut holder for mounting an electrical component package to a plate, comprising:
an electrically insulating body defining a bore;
a sleeve extending from the body, the sleeve defining a bore concentric with the bore in the body, a portion of the sleeve being adopted to fit into the electrical component package;
an adhesive coating on an exterior surface of the body for adhering the body to the electrical component package; and
a nut adapted to receive a threaded fastener and being in the body, the bore of the nut being concentric with the bore in the sleeve.

2. The insulating nut holder of claim 1, further comprising:
a ridge extending from the body; and
a lip defined at a distal portion of the ridge, wherein the lip is adapted to engage with the electrical component package, thereby preventing rotation of the insulating nut holder relative to the package.

3. The insulating nut holder of claim 1, wherein the sleeve has an external diameter adapted to be force fit in the package, thereby holding the insulating nut holder in place.

4. The insulating nut holder of claim 1, wherein the nut is of metal.

5. A method of mounting an electrical component package to a support, comprising the acts of:
adhering an electrically insulating nut holder to an external surface of the electrical component package;
placing the electrical component package adjacent the support; and
engaging a threaded fastener with threads of the insulating nut holder, the fastener head being on the opposite side of the support to the insulating nut holder, whereby tightening the fastener presses together the support and the electrical component package.

6. The method of claim 5 further comprising the act of providing a lip on the insulating nut holder, the lip engaging the electrical component package, thereby preventing the insulating nut holder from rotating when the fastener is tightened.

7. The method of claim 5 further comprising the act of locating insulation between the electrical component package and the support.

8. An assembly compromising:
an electrical component package;
an electrically insulating nut holder adhered to an external surface of the package;
a support to which the package is mounted; and
a threaded fastener passing through the support and the package and engaging threads in the insulating nut holder, whereby tightening the fastener presses together the support and the package.

9. The assembly of claim 8, wherein the insulating nut holder includes a metal nut in an insulating body.

10. The assembly of claim 8, further comprising:
a layer of insulating material between the electrical component package and the support.

11. The assembly of claim 10, wherein the insulating material is thermally conductive.

12. The assembly of claim 8, wherein the package defines a bore and the insulating nut holder has a sleeve extending therefrom, the sleeve being force fit in the bore.

13. The assembly of claim 8, wherein the insulating nut holder comprises:
an electrically insulating body;
a ridge extending from the body; and
a lip defined at a distal portion of the ridge, wherein the lip is adapted to engage with the package, thereby preventing rotation of the insulating nut holder relative to the package.
